(19) United States
(12) Patent Application Publication
(10) Pub. No.: US 2022/0287454 A1
(43) Pub. Date: Sep. 15, 2022

(54) Hands-Free Portable Device Holder

(71) Applicant: Reginald Eugene Wescott, SR., Philadelphia, PA (US)

(72) Inventor: Reginald Eugene Wescott, SR., Philadelphia, PA (US)

(21) Appl. No.: 17/197,602

(22) Filed: Mar. 10, 2021

(51) Int. Cl. A47B 23/00; F16M 13/04

(52) U.S. Cl. CPC A47B 23/002; F16M 13/04

(57) ABSTRACT

A hands-free portable device holder is an apparatus that comfortably and safely upholds a portable device such as a tablet or laptop around the waist of a user. The apparatus includes a support belt, a tabletop, and a position-locking mechanism. The support belt wraps around the waist of the user and is length-adjustable. The support belt also includes a first padded brace and a second padded brace that cushion the lower abdomen and the lower back of the user. The tabletop supports the portable device. The tabletop also includes a pullout tray to accommodate any accessories or small items that need to be or is preferably positioned beside the portable device. The position-locking mechanism positions and secures the desired orientation of the tabletop with the support belt, and consequently the torso of the user. The tabletop freely rotates about the support belt and is easily locked into a desired position.

### FIELD OF THE INVENTION

The present invention generally relates to electronic devices. More specifically, the present invention is a hands-free portable device holder.

### BACKGROUND OF THE INVENTION

Portable devices have become an integral tool for everyday activities. From relaxing at home to completing tasks at work, portable devices need to be within reach while multitasking. Throughout use of portable devices, such as laptops, smart phones, and tablets, accidents are more likely to occur. Accidents include dropping the portable device or losing the portable device.

It is therefore an objective of the present invention to provide accessibility for portable devices while sitting down, standing up, and moving around. The present invention safely upholds a portable device in front of the user. The present invention allows a user to continue with other activities while maintaining the position of the portable device directly in front of the user. The orientation of the portable device with the user is adjustable with the present invention. The present invention is compact and easily stored.

### BRIEF DESCRIPTION OF THE DRAWINGS

FIG. 1 is a front perspective view of the present invention in a folded-out position.

FIG. 2 is a front perspective view of the present invention in a folded-upright position.

FIG. 3 is a rear perspective view of the present invention in the folded-out position.

FIG. 4 is a rear perspective view of the present invention in the folded-out position with a pullout tray extend to the right side.

FIG. 5 is a rear perspective view of the present invention in the folded-out position with the pullout tray extend to the left side.

FIG. 6 is a top side view of the present invention in the folded-out position.

FIG. 7 is a cross-section view taken along line 7-7 in FIG. 6.

FIG. 8 is a magnified top side view of the present invention.

FIG. 9 is a cross-section view taken along line 9-9 in FIG. 8.

FIG. 10 is a schematic view of a tabletop and a heat resistance layer of the present invention.

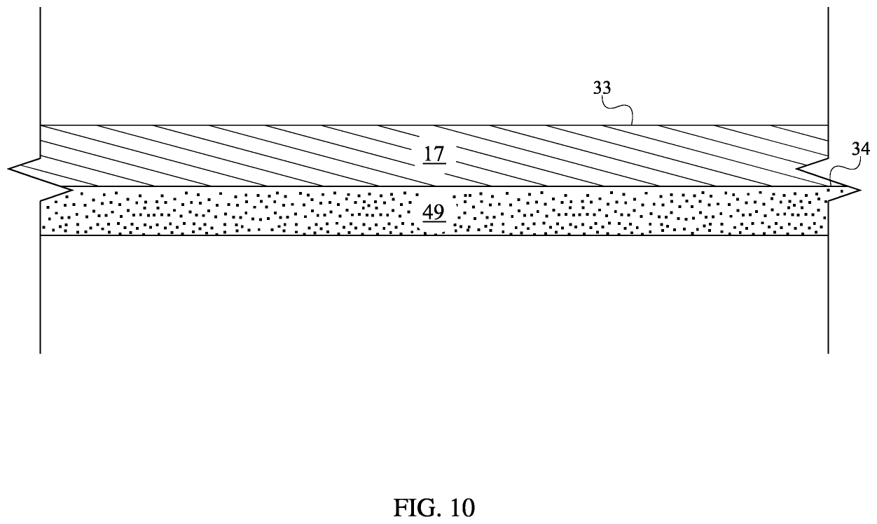

FIG. 11 is a magnified side view of a first buckle through a first selected hole from the plurality of first holes of the present invention.

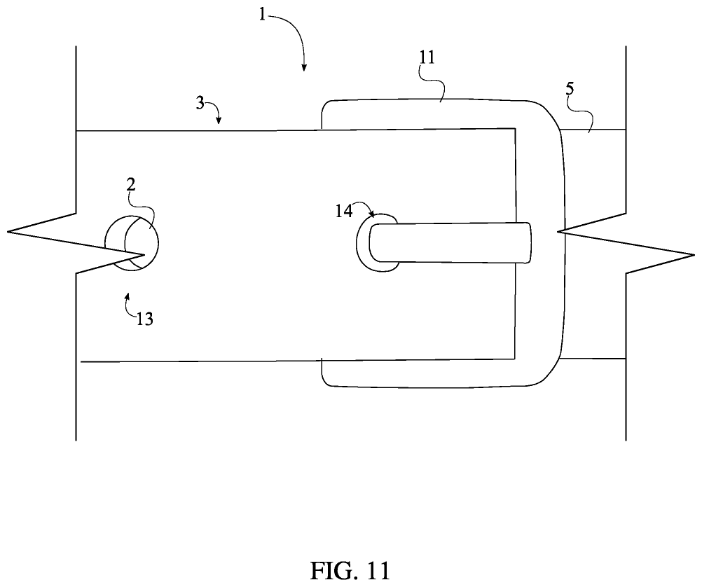

FIG. 12 is a magnified side view of a second buckle through a second selected hole from the plurality of second holes of the present invention.

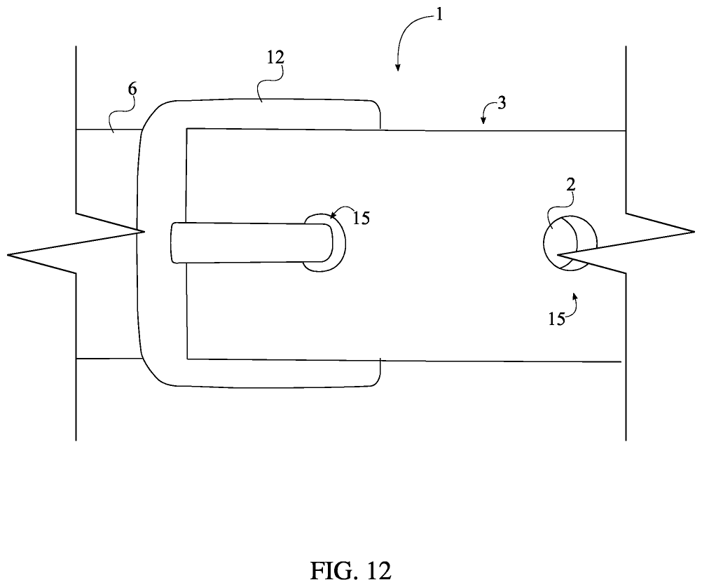

### DETAIL DESCRIPTIONS OF THE INVENTION

All illustrations of the drawings are for the purpose of describing selected versions of the present invention and are not intended to limit the scope of the present invention.

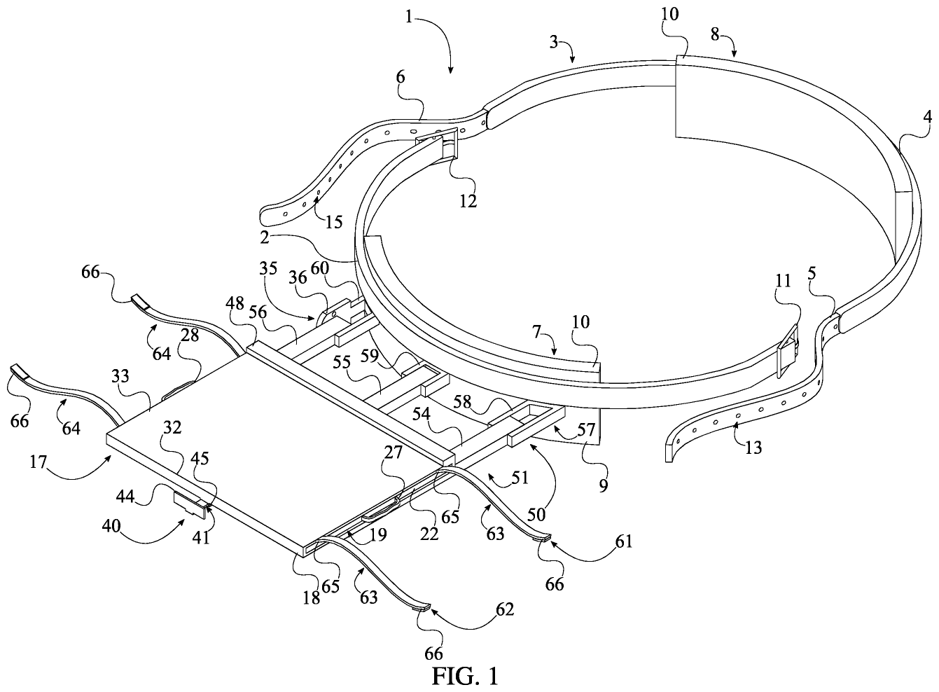

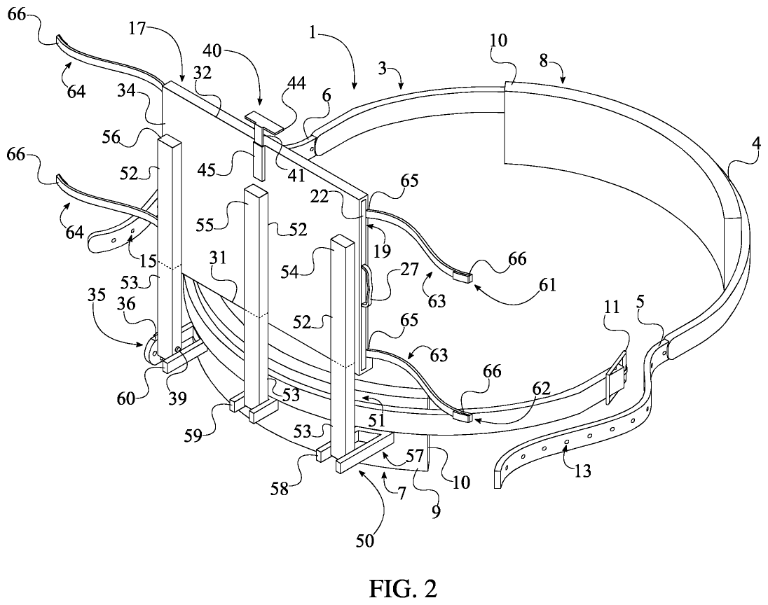

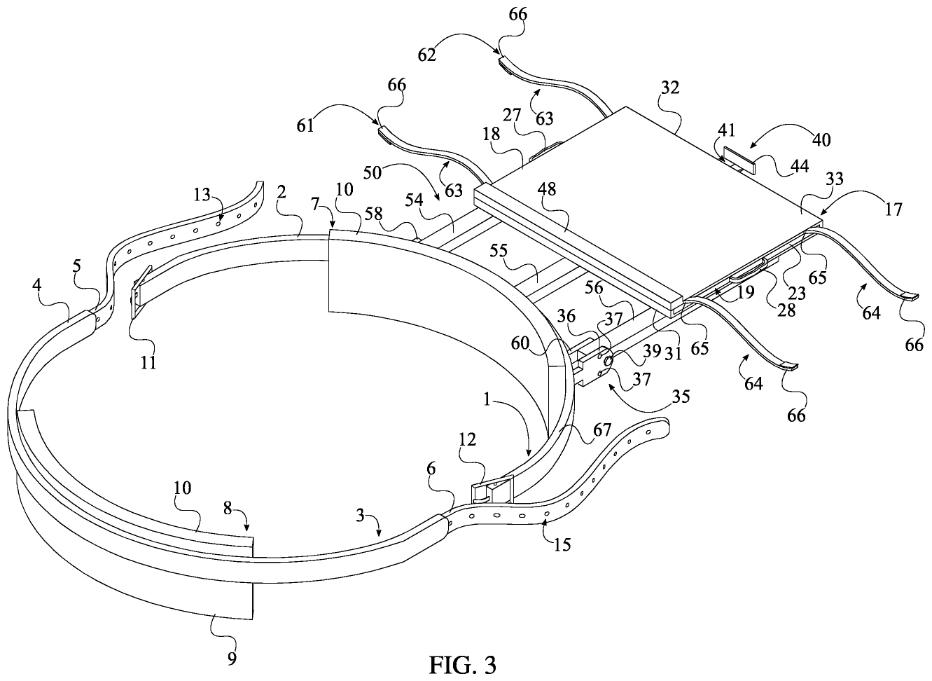

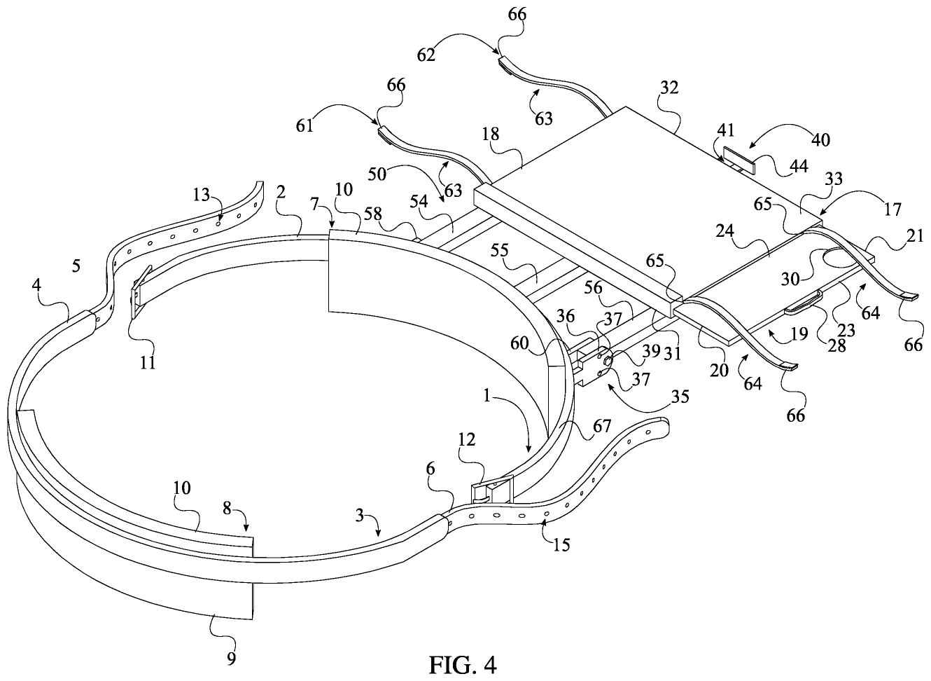

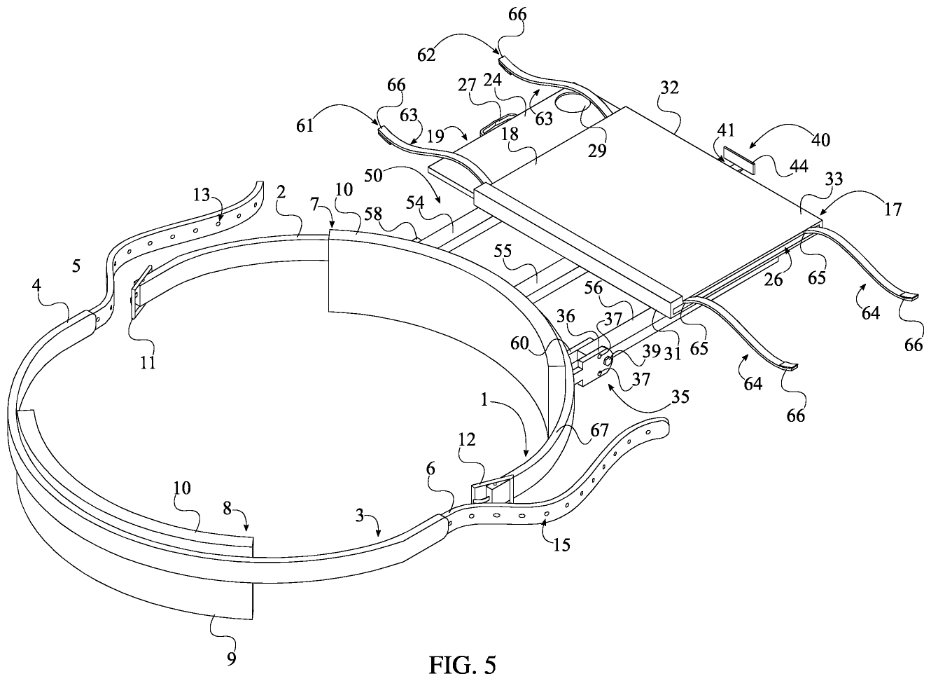

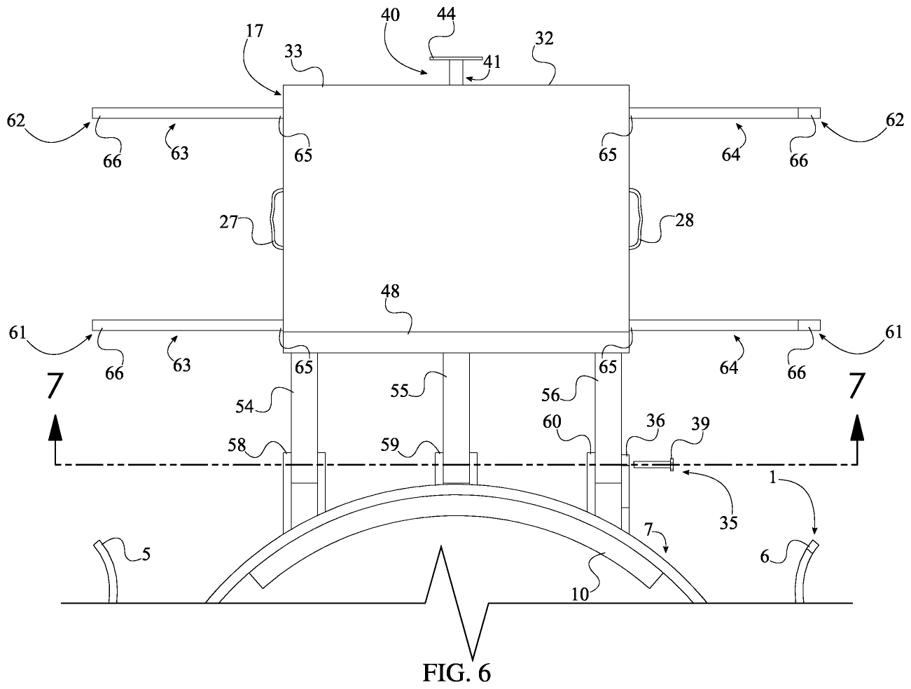

The present invention is a hands-free portable device holder. The present invention suspends a portable device, such as a tablet, a laptop, and so on, around the waist of the user. The present invention positions the portable device within a comfortable reach for the user as the user sits or moves around. More specifically, the present invention securely connects the portable device with the user while the user moves around so that the user may easily access the tablet, laptop, and smart phone. In order to for the present invention to be worn around by a user, the present invention may comprise a support belt 1, a tabletop 17, a position-locking mechanism 35, seen in FIG. 1, FIG. 2, FIG. 3, FIG. 4, FIG. 5, and FIG. 6. The support belt 1 wraps around the waist and rest on the hips of a user. The support belt 1 upholds the tabletop 17 from the waist of the user. The support belt 1 may comprise a main strap 2, a length-adjustable strap 3, a first padded brace 7, a second padded brace 8, a first buckle 11, a second buckle 12, a plurality of first holes 13, and a plurality of second holes 15. The main strap 2 connects the tabletop 17 with the support belt 1. The length-adjustable strap 3 connects the main strap 2 around the waist of the user and accommodates various sized users. The first padded brace 7 and the second padded brace 8 cushions the main strap 2 and the length-adjustable strap 3, respectively, around the user. Moreover, the first padded brace 7 and the second padded brace 8 absorbs and evenly distributes the force of the weight of the tabletop 17, as well as the portable device, around the waist of the user. In the preferred embodiment of the present invention, the first padded brace 7 and the second padded brace 8 are each made of memory foam material. More specifically, the first padded brace 7 presses against the lower abdomen of the user. Likewise, the second padded brace 8 presses against the lower back of the user. The first buckle 11 and the second buckle 12, together, attaches the main strap 2 with the length-adjustable strap 3. The plurality of first holes 13 and the plurality of second holes 15 allows the overall circumference of the support belt 1 to be adjustable with the first buckle 11 and the second buckle 12.

The tabletop 17 upholds the portable device in front of the user so that the user may easily and comfortably use the portable device, also seen in FIG. 1, FIG. 2, FIG. 3, FIG. 4, FIG. 5, and FIG. 6. The tabletop 17 also offsets the portable device from the lap of the user while the user is in a sitting position. The position-locking mechanism 35 locks the tabletop 17 in a desired orientation with the main strap 2, and consequently the position of the user.

The overall configuration of the aforementioned components securely and comfortably upholds a portable device directly in front of a user. In order for the first padded brace 7 to completely press across the lower abdomen of the user, the main strap 2 is fixed onto a distal surface 9 of the first padded brace 7, seen in FIG. 1 and FIG. 2. As seen in FIG. 3, FIG. 4, and FIG. 5. The length-adjustable strap 3 is fixed onto a distal surface 9 of the second padded brace 8, completely pressing across the lower back of the user. Each end of the length-adjustable strap 3 may be connected with the main strap 2 as the plurality of first holes 13 and the plurality of second holes 15 are positioned opposite each other along the length-adjustable strap 3. The plurality of first holes 13 and the plurality of second holes 15 traverse through the length-adjustable strap 3, thereby preserving the structural integrity of the length-adjustable strap 3. The length-adjustable strap 3 and the main strap 2 wrap around the waist of the user as the first buckle 11 is terminally connected with the main strap 2, and the second buckle 12 is terminally connected with the main strap 2, opposite the first buckle 11. A desired circumference of the support belt 1 is defined as the first buckle 11 is engaged with the length-adjustable strap 3 through a first selected hole from the plurality of first holes 13. Similarly, the second buckle 12 is engaged with the length-adjustable strap 3 through a second selected hole from the plurality of second holes 15. In order for the tabletop 17 to be positioned in front of the user, the tabletop 17 is hingedly connected onto the distal surface 9 of the first padded brace 7. In order for the desired orientation of the tabletop 17 to be locked with the support belt 1, the position-locking mechanism 35 is operatively integrated into the hinged connection between the tabletop 17 and the first padded brace 7. Moreover, the position-locking mechanism 35 is used to incrementally move the tabletop 17 in between a folded-upright position and a folded-out position. The folded-upright position orients the tabletop 17 parallel with the torso of the user, and the folded-out position orients the tabletop 17 perpendicular with the torso of the user. Moreover, the present invention is in a stored configuration while in the folded-out position, and in an extended configuration while in the folded-out position.

The present invention also upholds a variety of accessories for a portable device, including a variety of the small items a user may wish to be upheld by the present invention, the tabletop 17 may comprise a planar body 18, a pullout tray 19, a main slot 26, a left handle 27, and a right handle 28, seen in FIG. 3, FIG. 4, and FIG. 5. The planar body 18 serves as a platform for the portable device. The pullout tray 19 upholds accessories and small items beside the planar body 18, and consequently the portable device. In order for the pullout tray 19 to be positioned within the planar body 18, the pullout tray 19 may comprise a first lengthwise edge 20, a second lengthwise edge 21, a first widthwise edge 22, and a second widthwise edge 23. More specifically, the first lengthwise edge 20 is positioned opposite to the second lengthwise edge 21 across the planar body 18. Similarly, the first widthwise edge 22 is positioned opposite to the second widthwise edge 23 across the planar body 18. The main slot 26 accommodates the pullout tray 19 within the planar body 18 and preserves the structural integrity of the planar body 18 as the pullout tray 19 slides into and out of the planar body 18. The user easily accesses the pullout tray 19 with he left handle 27 and the right handle 28. The left handle 27 allows the user to pull the pullout tray 19 with the left hand, and the right handle 28 allows the user to pull out the pullout tray 19 with the right hand. In order for the pullout tray 19 to be stored within the planar body 18, the main slot 26 laterally traverses through the planar body 18. In order for the pullout tray 19 to be in a stored configuration with the planar body 18, the first lengthwise edge 20 and the second lengthwise edge 21 are positioned parallel with the main slot 26. Accessories and small items may rest on the pullout tray 19 as the pullout tray 19 is slidably mounted through the main slot 26. While in a stored configuration, the pullout tray 19 is accessible by the user as the first handle is fixed adjacent with the first widthwise edge 22, and the second handle is fixed adjacent with the second widthwise edge 23.

In the preferred embodiment of the present invention, the tabletop 17 further comprises a first cup-receiving indent 29 and a second cup-receiving indent 30, also seen in FIG. 3, FIG. 4, and FIG. 5. The first cup-receiving indent 29 and the second cup-receiving indent 30 each holds a cup or a small item of the like. Moreover, the pullout tray 19 may further comprise a first face 24 and a second face 25. A cup and a variety of small items press on the first face 24, and the second face 25 is presses against the planar body 18. Furthermore, the first face 24 is positioned opposite the second face 25 about the pullout tray 19 and is oriented towards an upper edge 67 of the support belt 1. The first cup-receiving indent 29 and the second cup-receiving indent 30 secures a position of a cup or small item as the first cup-receiving indent 29 and the second cup-receiving indent 30 traverses into the pullout tray 19 from the first face 24. The first cup-receiving indent 29 and the second cup-receiving indent 30 therefore serve as a border for the cup or small item. The cup or the small item positioned within the first cup-receiving indent 29 is safely positioned across the pullout tray 19 as the first cup-receiving indent 29 is positioned adjacent with the first widthwise edge 22. Similarly, the second cup-receiving indent 30 is positioned adjacent with the second widthwise edge 23. This arrangement positions prevents the cup or small item from being hit by the arm or hand of the user.

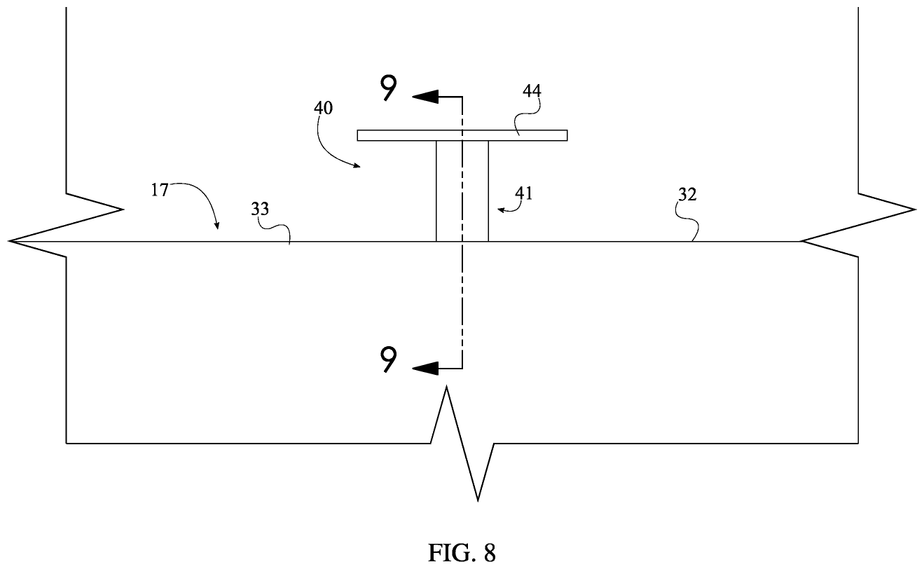

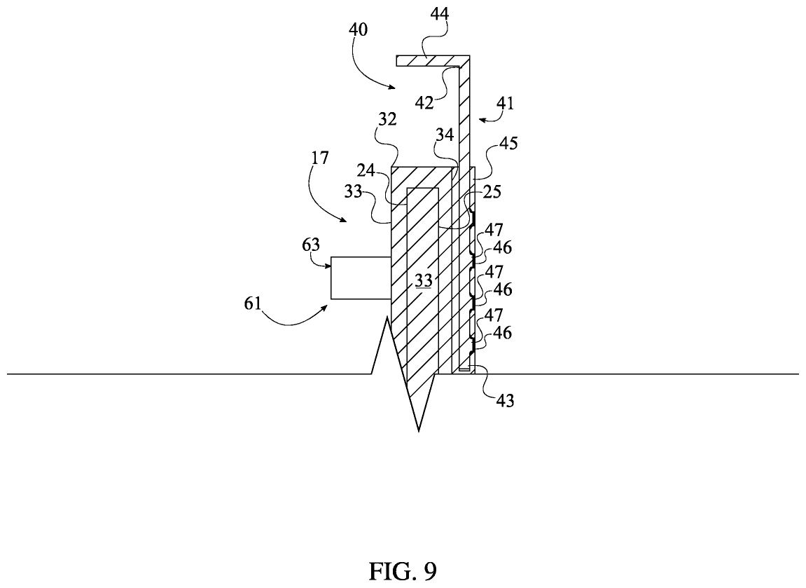

The present invention may further comprise a device holder 40 which secures and presents a small portable device such as a smart phone with the user. The device holder 40 may comprise an extension arm 41, a stopper plate 44, and a track 45, seen in FIG. 1, FIG. 2, FIG. 3, FIG. 4, FIG. 5, FIG. 6, FIG. 8. and FIG. 9. The extension arm 41 defines the depth of the device holder 40 in order to accommodate the width of a desired small portable device. The stopper plate 44 presses the small portable device against the tabletop 17. The track 45 allows the extension arm 41 to extend and retract from the tabletop 17. In order for the depth of the device holder 40 to be adjustable, the extension arm 41 each comprise a free end 42 and a fixed end 43. The free end 42 upholds the stopper plate 44, and the fixed end 43 secures the extension arm 41 within the track 45. The free end 42 is positioned opposite the fixed end 43 along the extension arm 41. Moreover, the stopper plate 44 is fixed adjacent with the free end 42 and is positioned normal with the extension arm 41. This arrangement presses the small portable device against the tabletop 17 and orients the small portable device upright with the tabletop 17. In order for the stopper plate 44 to be offset with the tabletop 17, the track 45 is laterally integrated into the tabletop 17, opposite to the first padded brace 7, and the fixed end 43 is slidably engaged into the track 45.

In the preferred embodiment of the present invention, the device holder 40 further comprises a plurality of notches 46 and a plurality of protrusions 47, seen in FIG. 9. The plurality of notches 46 and the plurality of protrusions 47 lock the desired depth of the device holder 40 and serve as the fastener for the device holder 40 with the tabletop 17. The extension arm 41 does not constantly slide across the track 45 as the plurality of notches 46 is distributed along the track 45 and traverses into the track 45. Furthermore, the plurality of protrusions 47 is distributed along the extension arm 41 and is positioned adjacent with the fixed end 43. The at least one specific protrusion from the plurality of protrusions 47 is engaged with at least one selected notch from the plurality of notches 46, thereby locking the desired position of the extension arm 41 within the track 45.

The present invention may further comprise a ledge 48 which stops a portable device from sliding off the tabletop 17 and pressing against the lower abdomen of the user, as shown in FIG. 1, FIG. 2, FIG. 3, FIG. 4, FIG. 5, and FIG. 6. The tabletop 17 may comprise a proximal lengthwise edge 31, a distal lengthwise edge 32, an upper surface 33, and a bottom surface 34. The proximal lengthwise edge 31 and the distal lengthwise edge 32 define the width of the tabletop 17. More specifically, the proximal lengthwise edge 31 is positioned beside the body of the user. The portable device presses onto the upper surface 33, and the bottom surface 34 presses against the lap of the user while the user is in a sitting position. In order to define the width of the tabletop 17, the proximal lengthwise edge 31 is positioned opposite to the distal lengthwise edge 32 across the tabletop 17. The portable device is offset from the lap of the user as the upper surface 33 is positioned opposite to the bottom surface 34 about the tabletop 17. As the proximal lengthwise edge 31 is positioned beside the lower abdomen of the user, the proximal lengthwise edge 31 is positioned adjacent with the first padded brace 7. The ledge 48 stops the portable device from sliding towards the user and pressing against the lower abdomen of the user as the ledge 48 is positioned adjacent with the upper surface 33 and traverses along the proximal lengthwise edge 31. More specifically, the ledge 48 is fixed onto the upper surface 33, effectively supporting the weight of the portable device pressing against the ledge 48. In order to further protect the user from the heat emitted from the portable device, alternate embodiments of the present invention further comprise a heat resistance layer 49. The heat resistance layer 49 is fixed across the bottom surface 34 as the bottom surface 34 presses against the lap of the user while in a sitting position.

In order for the tabletop 17 to safely pivot with the support belt 1, the present invention may comprise a hinge assembly 50, seen in FIG. 1, FIG. 2, FIG. 3, FIG. 4, FIG. 5, and FIG. 6. The hinge assembly 50 may comprise at least one stabilizing bar 51 and at least one U-shaped bracket 57. The at least one stabilizing bar 51 connects and offsets the tabletop 17 with the at least one U-shaped bracket 57. The at least one U-shaped bracket 57 mounts the at least one stabilizing bar 51 with the support belt 1. The orientation of the tabletop 17 is adjusted with the position-locking mechanism 35 as the position-locking mechanism 35 may comprise a semicircular base plate 36, a plurality of pin-receiving holes 37, a locking hole 38, and a lock pin 39. The semicircular base plate 36 serves to connect the lock pin 39 with the at least one stabilizing bar 51. The plurality of pin-receiving holes 37 allows the lock pin 39 to traverse through the semicircular plate and defines the orientation of the tabletop 17 with the support belt 1. The locking hole 38 allows the lock pin 39 to traverse through the at least one stabilizing bar 51 and secure a desired position for the at least one stabilizing bar 51 with a pin-receiving hole of the plurality of pin-receiving holes 37. A portable device is evenly positioned across the top surface of the tabletop 17 as the at least one stabilizing bar 51 is positioned adjacent with the bottom surface 34. More specifically, a distal end 52 of the at least one stabilizing bar 51 is fixed across the bottom surface 34. The distal end 52 supports the tabletop 17. The first padded brace 7 evenly presses against the lower abdomen of the user as the at least one U-shaped bracket 57 is mounted onto the distal surface 9 of the first padded brace 7. In order for the at least one stabilizing bar 51 to rotate with the U-shaped bracket, a proximal end 53 of the at least one stabilizing bar 51 is positioned into the at least one U-shaped bracket 57 and is hingedly connected with the at least one U-shaped bracket 57. In order to engage the lock pin 39 with both the semicircular base plate 36 and the at least one stabilizing bar 51 the semicircular base plate 36 is laterally integrated into the at least one U-shaped bracket 57. The plurality of pin-receiving holes 37 is radially distributed about the semicircular base plate 36 and traverses through the semicircular base plate 36, thereby defining the possible orientations of the tabletop 17 with the support belt 1. The tabletop 17 is safely oriented in the folded-out position as the locking hole 38 laterally traverses into the at least one stabilizing bar 51, adjacent to the proximal end 53 of the at least one stabilizing bar 51. The lock pin 39 is engaged through a selected hole from the plurality of pin-receiving holes 37 and into the locking hole 38. This arrangement locks the tabletop 17 in a desired orientation that corresponds to the position of the selected hole across the semicircular base plate 36.

In order to fully support the tabletop 17 across the length of the tabletop 17, the at least one stabilizing bar 51 may comprise a first-side bar 54, a central bar 55, and a second-side bar 56, seen in FIG. 1, FIG. 2, FIG. 3, FIG. 4, FIG. 5, and FIG. 6. The first-side bar 54 and the second-side bar 56 support the side areas of the tabletop 17 and the central bar 55 supports the middle area of the tabletop 17. A length of the first-side bar 54 and a length of the second-side bar 56 are equal to each other and are greater than a length of the central bar 55. This arrangement accommodates the contour of the support belt 1 around the waist of the user. The at least one U-shaped bracket 57 may comprise a first-side bracket 58, a central bracket 59, and a second-side bracket 60. The first-side bracket 58 connects the first-side bar 54 with the support belt 1, the second-side bracket 60 connects the second-side bar 56 with the support belt 1, and the central bracket 59 connects the central bar 55 with the support belt 1. In order to stabilize the tabletop 17 with the support belt 1, the central bracket 59 is positioned in between the first-side bracket 58 and the second-side bracket 60. The tabletop 17 freely rotates as the first-side bar 54 is hingedly connected with the first-side bracket 58, the central bar 55 is hingedly connected with the central bracket 59, and the second-side bar 56 is hingedly connected with the second-side bracket 60. The position-locking mechanism 35 is easily accessible with the lock pin 39 as the semicircular base plate 36 is integrated into the second-side bracket 60, and the locking hole 38 traverses through the second-side bar 56. The lock pin 39 freely may then freely traverse through a selected hole from the plurality of pin-receiving holes 37 across the semicircular base plate 36 and the lock hole through the second-side bar 56.

In order to adjust the overall circumference of the support belt 1, the length-adjustable strap 3 may comprise a bracing portion 4, a left-side portion 5, and a right-side portion 6, seen in FIG. 1, FIG. 2, FIG. 3, FIG. 4, and FIG. 5. The bracing portion 4 presses against the lower back of user. The left-side portion 5 wraps around the left side of the body of the user, and the right-side portion 6 wraps around the right side of the body of the user. The length-adjustable strap 3 contours around the waist of the user as the bracing portion 4 is positioned in between the left-side portion 5 and the right-side portion 6. The second padded brace 8 traverses across the bracing portion 4 and is fixed with the bracing portion 4 in order to relieve the stress of the weight of the tabletop 17 and the portable device against the lower back of the user. In order for the first buckle 11 to connect with the length-adjustable strap 3, the plurality of first holes 13 is distributed along the left-side portion 5. Similarly, in order for the second buckle 12 to connect with the length-adjustable strap 3, the plurality of second holes 15 is distributed along the right-side portion 6.

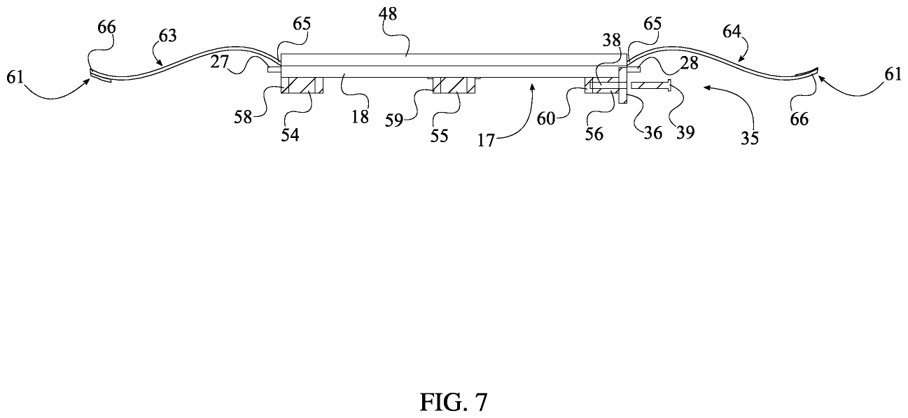

The position of a portable device on the tabletop 17 is secured as the present invention may further comprise a pair of first length-adjustable fasteners 61 and a pair of second length-adjustable fasteners 62, seen in FIG. 1, FIG. 2, FIG. 3, FIG. 4, FIG. 5, FIG. 6, and FIG. 7. The pair of first length-adjustable fasteners 61 and the pair of second length-adjustable fasteners 62 loop around the tabletop 17 and across the portable device, preventing the portable device from slipping past the tabletop 17 throughout any movement of the user. For example, if the portable device is a laptop, the pair of first length-adjustable fastener 61 and the pair of second length-adjustable fasteners 62 secures around the base of the laptop while leaving the keyboard uninhibited. Furthermore, if the portable device is a tablet, the pair of first length-adjustable fastener 61 and the pair of second length-adjustable fasteners 62 secures the tablet with the tabletop 17 across the rim of the tablet so that the touch screen also remains uninhibited. Furthermore, the pair of first length-adjustable fasteners 61 and the pair of second length-adjustable fasteners 62 may each comprise a left-side strap 63 and a right-side strap 64. The left-side strap 63 and the right-side strap 64 stretches across the left side and the right-side of the tabletop 17, and consequently the portable device, respectively. The left-side strap 63 and the right-side strap 64 also account for portable devices of varying thicknesses and shapes. The pair of first length-adjustable fasteners 61 does not inhibit access to the portable device for the user as the pair of first length-adjustable fasteners 61 is positioned adjacent with the proximal lengthwise edge 31. Similarly, the pair of second length-adjustable fasteners 62 does not inhibit access to the portable device for the user as the pair of second length-adjustable fasteners 62 is positioned adjacent with the distal lengthwise edge 32. A fixed end 65 of the left-side strap 63 is laterally fixed with the tabletop 17, thereby securing the left-side strap 63 with the tabletop 17. A fixed end 65 of the right-side strap 64 is laterally fixed with the tabletop 17, opposite the left-side strap 63, thereby securing the right-side strap 64 with the tabletop 17. In order to facilitate the placement of the portable device beneath the left-side strap 63 and the right-side strap 64, as well as the removal of the portable device from the left-side strap 63 and the right-side strap 64, a free end 66 of the left-side strap 63 is engaged with a free end 66 of the right-side strap 64. In the preferred embodiment of the present invention, the free end 66 of the left-side strap 63 and the free end 66 of the right-side strap 64 are removably connected with Velcro patches or Velcro straps.

Furthermore, for the preferred embodiment of the present invention, the first padded brace 7 and the second padded brace 8 may each comprise an arc-shaped brace body 10, seen in FIG. 1, FIG. 2, FIG. 3, FIG. 4, FIG. 5, and FIG. 6. The arc-shaped brace body 10 provides the present invention with an ergonomic construction around the waist of the user. The arc-shaped brace body 10 also reduces the stress against the main strap 2 and the length-adjustable strap 3, respectively, while the support belt 1 is tightened around the waist of the user. The user is able to easily wear and secure the support belt 1 around the waist as the arc-shaped brace body 10 of the first padded brace 7 and the arc-shaped brace body 10 of the second padded brace 8 is positioned concentric to each other.

Although the invention has been explained in relation to its preferred embodiment, it is to be understood that many other possible modifications and variations can be made without departing from the spirit and scope of the invention as hereinafter claimed.

What is claimed is:

1. A hands-free portable device holder comprises:
a support belt;
a tabletop;
a position-locking mechanism;
the support belt comprises a main strap, a length-adjustable strap, a first padded brace, a second padded brace, a first buckle, a second buckle, a plurality of first holes, and a plurality of second holes;
the main strap being fixed onto a distal surface of the first padded brace;
the length-adjustable strap being fixed onto a distal surface of the second padded brace;
the plurality of first holes and the plurality of second holes being positioned opposite each other along the length-adjustable strap;
the plurality of first holes and the plurality of second holes traversing through the length-adjustable strap;
the first buckle being terminally connected with the main strap;
the second buckle being terminally connected with the main strap, opposite the first buckle;
the first buckle being engaged with the length-adjustable strap through a first selected hole from the plurality of first holes;
the second buckle being engaged with the length-adjustable strap through a second selected hole from the plurality of second holes;
the tabletop being hingedly connected onto the distal surface of the first padded brace; and,
the position-locking mechanism being operatively integrated into the hinged connection between the tabletop and the first padded brace, wherein the position-locking mechanism is used to incrementally move the tabletop in between a folded-upright position and a folded-out position.

2. The hands-free portable device holder as claimed in claim 1 comprises:
the tabletop comprises a planar body, a pullout tray, a main slot, a left handle, and a right handle;
the pullout tray comprises a first lengthwise edge, a second lengthwise edge, a first widthwise edge, and a second widthwise edge;
the first lengthwise edge being positioned opposite to the second lengthwise edge across the planar body;
the first widthwise edge being positioned opposite to the second widthwise edge across the planar body;
the main slot laterally traversing through the planar body;
the first lengthwise edge and the second lengthwise edge being positioned parallel with the main slot;
the pullout tray being slidably mounted through the main slot;
the first handle being fixed adjacent with the first widthwise edge; and,
the second handle being fixed adjacent with the second widthwise edge.

3. The hands-free portable device holder as claimed in claim 2 comprises:
the tabletop further comprises a first cup-receiving indent and a second cup-receiving indent;
the pullout tray further comprises a first face and a second face;
the first face being positioned opposite the second face about the pullout tray;
the first face being oriented toward an upper edge of the support belt;
the first cup-receiving indent and the second cup-receiving indent traversing into the pullout tray from the first face;
the first cup-receiving indent being positioned adjacent with the first widthwise edge; and,
the second cup-receiving indent being positioned adjacent with the second widthwise edge.

4. The hands-free portable device holder as claimed in claim 1 comprises:
a device holder;
the device holder comprises an extension arm, a stopper plate, and a track;
the extension arm comprises a free end and a fixed end;
the free end being positioned opposite the fixed end along the extension arm;
the stopper plate being fixed adjacent with the free end;
the stopper plate being positioned normal with the extension arm;
the track being laterally integrated into the tabletop, opposite to the first padded brace; and,
the fixed end being slidably engaged into the track.

5. The hands-free portable device holder as claimed in claim 4 comprises:
the device holder further comprises a plurality of notches and a plurality of protrusions;
the plurality of notches being distributed along the track;
the plurality of notches traversing into the track;
the plurality of protrusions being distributed along extension arm;
the plurality of protrusions being positioned adjacent with the fixed end; and,
at least one specific protrusion from the plurality of protrusions being engaged with at least one selected notch from the plurality of notches.

6. The hands-free portable device holder as claimed in claim 1 comprises:
a ledge;
the tabletop comprises a proximal lengthwise edge, a distal lengthwise edge, an upper surface, and a bottom surface;
the proximal lengthwise edge being positioned opposite to the distal lengthwise edge across the tabletop;
the upper surface being positioned opposite to the bottom surface about the tabletop;
the proximal lengthwise edge being positioned adjacent with the first padded brace;
the ledge being positioned adjacent with the upper surface;
the ledge traversing along the proximal lengthwise edge; and,
the ledge being fixed onto the upper surface.

7. The hands-free portable device holder as claimed in claim 1 comprises:
a heat resistance layer;
the tabletop further comprises an upper surface and a bottom surface;
the upper surface being positioned opposite the bottom surface about the tabletop; and,
the heat resistance layer being fixed across the bottom surface.

8. The hands-free portable device holder as claimed in claim 1 comprises:
a hinge assembly;
the hinge assembly comprises at least one stabilizing bar and at least one U-shaped bracket;
the tabletop comprises an upper surface and bottom surface;
the position-locking mechanism comprises a semicircular base plate, a plurality of pin-receiving holes, a locking hole, and a lock pin;
the upper surface being positioned opposite to the bottom surface about the tabletop;
the at least one stabilizing bar being positioned adjacent with the bottom surface;
a distal end of the at least one stabilizing bar being fixed across the bottom surface;
the at least one U-shaped bracket being mounted onto the distal surface of the first padded brace;
a proximal end of the at least one stabilizing bar being positioned into the at least one U-shaped bracket;
the proximal end being hingedly connected with the at least one U-shaped bracket;
the semicircular base plate being laterally integrated into the at least one U-shaped bracket;
the plurality of pin-receiving holes being radially distributed about the semicircular base plate;
the plurality of pin-receiving holes traversing through the semicircular base plate;
the locking hole laterally traversing into the at least one stabilizing bar, adjacent to the proximal end of the at least one stabilizing bar; and,
the lock pin being engaged through a selected hole from the plurality of pin-receiving holes and into the locking hole.

9. The hands-free portable device holder as claimed in claim 8 comprises:
the at least one stabilizing bar comprises a first-side bar, a central bar, and a second-side bar;
the at least one U-shaped bracket comprises a first-side bracket, a central bracket, and a second-side bracket;
the central bracket being positioned in between the first-side bracket and the second-side bracket;
the first-side bar being hingedly connected with the first-side bracket;
the central bar being hingedly connected with the central bracket;
the second-side bar being hingedly connected with the second-side bracket;
the semicircular base plate being integrated into the second-side bracket; and,
the locking hole traversing through the second-side bar.

10. The hands-free portable device holder as claimed in claim 9, wherein a length of first-side bar and a length of the second-side bar equal to each other and are greater than a length of the central bar.

11. The hands-free portable device holder as claimed in claim 1 comprises:
the length-adjustable strap comprises a bracing portion, a left-side portion, and a right-side portion;
the bracing portion being positioned in between the left-side portion and the right-side portion;
the second padded brace traversing across the bracing portion;
the second padded brace being fixed with the bracing portion;
the plurality of first holes being distributed along the left-side portion; and,
the plurality of second holes being distributed along the right-side portion.

12. The hands-free portable device holder as claimed in claim 1 comprises:
a pair of first length-adjustable fasteners;
a pair of second length-adjustable fasteners;
the tabletop comprises a proximal lengthwise edge and a distal lengthwise edge;
the pair of first length-adjustable fasteners and the pair of second length-adjustable fasteners each comprise a left-side strap and a right-side strap;
the proximal lengthwise edge being positioned opposite to the distal lengthwise edge across the tabletop;
the pair of first length-adjustable fasteners being positioned adjacent with the proximal lengthwise edge;
the pair of second length-adjustable fasteners being positioned adjacent with the distal lengthwise edge;
a fixed end of the left-side strap being laterally fixed with the tabletop;
a fixed end of the right-side strap being laterally fixed with the tabletop, opposite the left-side strap; and,
a free end of the left side strap being engaged with a free end of the right-side strap.

13. The hands-free portable device holder as claimed in claim 1 comprises:
the first padded brace and the second padded brace each comprise an arc-shaped brace body; and,
the arc-shaped brace body of the first padded brace and the arc-shaped brace body of the second padded brace being positioned concentric to each other.
